(19) United States
(12) Patent Application Publication
(10) Pub. No.: US 2003/0126608 A1
(43) Pub. Date: Jul. 3, 2003

(54) Methods and systems for providing streaming media content in existing video delivery systems

(75) Inventors: Reem Safadi, Horsham, PA (US); Carl McGrath, Chalfont, PA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 10/036,560

(22) Filed: Dec. 31, 2001

(51) Int. Cl. H04N 7/173; H04N 7/16

(52) U.S. Cl. 725/89; 725/132; 725/140; 725/111

(57) ABSTRACT

Methods and systems for the provision of streaming media content in existing video delivery systems are provided. Streaming media content may be delivered over an existing video delivery system by (1) downloading a streaming media player to a consumer device and processing the streaming media content for delivery over the existing delivery network for decoding and display by the player; and/or (2) transcoding the streaming media content for display on a consumer device and delivering the transcoded streaming media content over the existing delivery network to the consumer device. Processing of the streaming media content may comprise encapsulating the streaming media content in an MPEG-2 transport stream for delivery over the existing network. Transcoding of the streaming media content may comprise converting the content from an original format to another format compatible with the consumer device and/or a player resident at the consumer device, such as an MPEG-2 program stream. Various hybrid systems using features of both types of delivery methods may be developed and implemented in accordance with the invention.

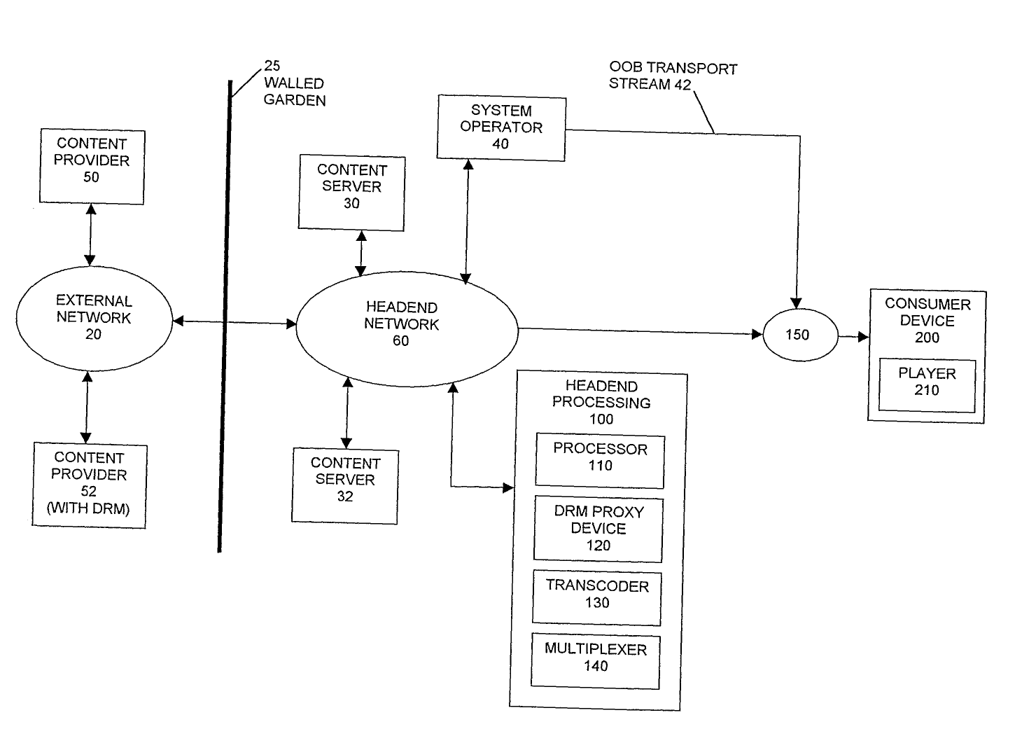

### BACKGROUND OF THE INVENTION

The present invention relates to the delivery of streaming media content and services. More specifically, the present invention relates to providing streaming media content and services in an existing video delivery system (such as cable, satellite, or off-air broadcast systems).

Streaming media is a technology used to deliver multimedia information, such as audio, video, images, graphics, or other data, typically over a non-traditional video delivery network, such as the Internet, without the need to first download an entire file for later playback. Media streaming is enabled by a set of protocols, such as Internet Protocol (IP), encapsulating User Data Protocol (UDP) data units, and encapsulating Real Time Protocol (RTP) data units in conjunction with Real Time Control Protocol (RTCP), for real time management and delivery of audio-visual streams. Other protocols also apply and are known to those skilled in the art. These enabling protocols allow the delivery of content at a near real time rate using buffering (e.g., up to two seconds) to compensate for network throughput and delays. Therefore, the streaming media content can be viewed and/or listened to as it is received. This is accomplished through the use of a streaming media “player,” which can be downloaded and used multiple times to decode and present received streaming media audio and video files. Streaming media content is normally delivered over the Internet or other similar networks to a personal computer having a downloaded player. Various media players, exist, examples of which include RealNetworks' RealPlayer®, Microsoft's Media Player, and Apple Computer's QuickTime®.

There are several devices that work in conjunction with a television appliance and use the cable delivery system to provide access to the Internet. These devices require a separate Internet connection (e.g., via a telephone line). This configuration in effect does not take advantage of the video delivery mechanisms that are already in place in a video delivery system such as a cable television system.

Currently there are no scenarios that address how streaming media may be incorporated for delivery in existing video delivery systems.

It would be advantageous to provide methods and systems for delivering streaming media content using existing video delivery systems. It would be further advantageous to provide digital rights management of such streaming media content delivered over the existing video delivery system. It would be still further advantageous to provide a system for generating revenue for the video delivery system operator from the delivery of the streaming media content, either from the consumer on a pay-per-use or subscription basis, or from a third party streaming media content provider. It would be still further advantageous to provide compatibility between the streaming media content encoding and consumer device decoding capabilities, without the need for multiple streaming media players at the consumer device. It would also be advantageous to provide for management of the rights to the content, regardless of the source of the content or the rights management scheme used by the content provider.

The methods and systems of the present invention provide the foregoing and other advantages.

### SUMMARY OF THE INVENTION

The present invention provides methods and systems for the provision of streaming media in existing video delivery systems. Streaming media content may be delivered over an existing video delivery system by (1) downloading a streaming media player to a consumer device and processing the streaming media content for delivery over the existing television network for decoding and display by the player; and/or (2) transcoding the streaming media content for display on a consumer device and delivering the transcoded streaming media content over the existing delivery network to the consumer device. Methods and apparatus are provided which provide for both types of delivery systems. The processing of the streaming media content may comprise encapsulating the streaming media content in an MPEG-2 transport stream for delivery over the existing network (e.g., a cable or satellite network). Transcoding of the streaming media content may comprise converting the content from an original format to another format compatible with the consumer device and/or a player resident in the consumer device, such as an MPEG-2 program stream. Those skilled in the art will appreciate that various hybrid systems using features of both types of delivery methods may be developed and implemented in accordance with the invention.

### BRIEF DESCRIPTION OF THE DRAWING

The present invention will hereinafter be described in conjunction with the appended drawing FIGURE, which shows a block diagram of an exemplary embodiment of the invention.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

In a first exemplary embodiment as shown in the FIGURE, methods and systems are disclosed for providing streaming media in an existing video delivery system operated by a system operator 40. The existing video delivery system may include the headend network 60, the system operator 40 (i.e. system controller), headend processing system 100, and a plurality of consumer devices 200, as well as other related components as is known in the art.

The streaming media content may be provided by content providers 50, 52 and/or by content servers 30, 32. Content servers 30, 32 may be part of the existing video delivery system and under the control of the system operator 40. The FIGURE shows only two content providers 50, 52 and two content servers 30, 32 for ease of explanation. Those skilled in the art will appreciate that a multitude of content providers and content servers may be available to provide streaming media content to the consumer device.

In the illustrated embodiment, a player 210 for streaming media content is securely downloaded to a consumer device 200 via the existing delivery network (e.g., headend network 60). The streaming media content is processed by a processor 110 for delivery over the existing delivery network 60 to the consumer device 200 for decoding and display by the player 210.

The consumer device 200 may comprise any one of a plurality of consumer devices in the video delivery system, such as a television, a set-top terminal, a satellite decoder, personal computer, an Internet appliance associated with the video delivery system (e.g., a web pad enabled for communications with a set-top terminal), or any other display device which may be integrated into the existing video delivery system.

The processing of the streaming media content by processor 110 may comprise encapsulating the streaming media content in an MPEG-2 transport stream. Where the streaming media content is encapsulated in an MPEG-2 transport stream, a multiplexer 140 may be provided for multiplexing the MPEG-2 transport stream with additional MPEG-2 transport streams to provide a new multiplexed MPEG-2 transport stream for delivery to the consumer device 200. Carriage of IP data within MPEG-2 transport streams is described in commonly assigned U.S. patent application Ser. No. 09/642,544 entitled “System & Method for Facilitating Transmission of IP Data over Digital MPEG Networks”, filed on Aug. 18, 2000.

Alternatively, the processing of the streaming media content by processor 110 may comprise providing the streaming media to the consumer device 200 using Data Over Cable Service Interface Specification (DOCSIS). Further, the streaming media content may be transcoded at transcoder 130 from a first format to a second format compatible with the player 210 resident in the consumer device 200. For example, the streaming media content may be transcoded from an original format to an MPEG-2 program stream. Where the streaming media content is re-encoded as an MPEG-2 program stream, the MPEG-2 program stream may be multiplexed with additional MPEG-2 program streams at multiplexer 140 to provide a new multiplexed MPEG-2 transport stream for delivery to the consumer device 200. In addition, the streaming media content may first be transcoded at transcoder 130 from a first format to a second format and then encapsulated at processor 110 in an MPEG-2 transport stream for delivery over the existing delivery network 60 to the consumer device 200. Transcoding is also well known in the art as can be seen, for example, in U.S. Pat. No. 6,275,536 to X. Chen, et al. entitled “Implementation Architectures of a Multi-Channel MPEG Video Transcoder Using Multiple Programmable Processors.”

Definitions and technical details regarding MPEG-2 program streams and MPEG-2 transport streams may be found in The International Standards Organization (ISO) standard entitled “Generic Coding of Moving Pictures and Associated Audio: Systems, Recommendation H.222.0”, ISO/IEC JTC1/SC29/WG11 N0801 (Nov. 13, 1994), incorporated herein by reference.

Those skilled in the art will appreciate that the streaming media content may be encoded and/or compressed using a variety of schemes. A substitute player may be securely downloaded in place of the existing player 210 in order to accommodate a different encoding scheme of the streaming media content requested by the consumer. The existing player 210 may be a previously downloaded player or a default player installed by the manufacturer of the consumer device 200. Alternatively, an additional player may be securely downloaded to the consumer device 200 in order to accommodate a different encoding scheme of the streaming media content. In such an embodiment, the consumer device 200 would be capable of downloading and storing more than one player 210.

The delivery of streaming media content may be tracked by the system operator 40. Tracking of the delivery of the streaming media content will facilitate billing and billing verification for the streaming media content delivery as well as other revenue generating opportunities. For example, a percentage of a fee for delivery of the streaming media content from a streaming media content provider (e.g., content providers 50, 52) may be paid to the system operator 40. The fee is enabled by referral information embedded in a uniform resource locator (URL) associated with the content. For example, the system operator's portal URL may be detected by the content provider's web site indicating that a user is on the system operator's network 60. URL notations and usages are described in various Request for Comment (RFC) documents published by the Internet Engineering Task Force (IETF), such as “Uniform Resource Locators (URL),” RFC 1738, dated December, 1994 and “Universal Resource Identifiers in WWW,” RFC 1630, dated June 1994.

The player 210 may be securely downloaded from within the system operator's walled garden 25. The streaming media content may be provided from outside of the walled garden 25. The walled garden 25 provides a measure of security to the system operator 40 and consumer devices by limiting access to non-qualified sites outside the headend network 60. Only content from selected content providers 50, 52 may be accessed by the consumer device 200. The content may be provided on a conditional access basis by either the system operator 40 or a content provider 50, 52.

Digital rights management (DRM) of the content may be provided by one of the system operator 40 or a content provider 52. DRM secures the sale of content and protects against illegal, unauthorized distribution and playback of content. DRM may also allow for copy control, including anti-copying features, conditional copy features, and generational copy-control features. DRM protects content owners, distributors, and retailers. Digital rights management may comprise encrypting of the streaming media content for secure delivery. Digital rights management may be enabled using extensible rights markup language (XrML). The FIGURE shows content provider 52 as having DRM capabilities for purposes of illustration only. Those skilled in the art will appreciate that there may be a multitude of content providers, each having a different DRM scheme.

In this embodiment, third party (e.g., content providers 50, 52) DRM schemes may be converted to a system operator's native DRM scheme by a processor 110 (in connection with DRM proxy device 120) to enable secure delivery of streaming media content from multiple third parties (e.g., content providers 50, 52) over the existing delivery network 60. The native DRM scheme may comprise any DRM scheme now known in the art or subsequently developed. Various DRM schemes are already well known, and can be found in the literature. Examples include DRM schemes available from Real Networks, Intertrust, Microsoft, IBM, and others.

The DRM proxy device 120 receives a request made via the consumer device 200 for specific content over the existing network 60 and forwards the request to the content provider over the external network 20. The DRM proxy device 120 therefore acts as an invisible intermediary between the content providers 50, 52 and the consumer device 200. The DRM proxy device 120 receives the requested content from the content provider(s) 50, 52 as if it were the consumer device 200. The DRM proxy device 120 is privy to the security parameters of the consumer device 200, and can therefore receive the content on behalf of the consumer device 200. The processor 110 can then terminate the original DRM scheme (e.g., decrypt and otherwise gain access to the content as if it had been received by the consumer device 200), and then repackage the content with the native DRM scheme for secure delivery to the consumer device 200 via the DRM proxy device 120 over the existing network 60. In this way, the identity of the consumer device 200 is maintained as far as the content provider is concerned, and security and conditional access rights for each consumer device 200 in the network can remain unchanged. It should be appreciated that revenue distribution in the foregoing scenario may be based on prior agreements between the parties involved (e.g., between the system operator 40 and the content providers 50, 52).

The FIGURE shows the multiplexer 140, transcoder 130, DRM proxy device 120, and processor 110 as included within headend processing system 100. Those skilled in the art will appreciate that such a representation is functional in nature only, and that the multiplexer 140, transcoder 130, DRM proxy device 120, and processor 110 may be located at different locations in the headend as separate devices. Alternatively, the functions of the transcoder 130, DRM proxy device 120, and processor 110, as well as other headend functions, may be combined in a single device, or embodied in various combinations of hardware, software and firmware.

In an alternate embodiment, the consumer device 200 may be enabled to accommodate multiple DRM software implementations.

The streaming media content may be provided by a third party content provider 50, 52, or the system operator 40 (e.g., from content servers 30, 32). The player 210 may be either a third party content provider's player or a system operator's player.

Channel maps may be modified (e.g., at headend processing system 100 by processor 110) to reflect the presence of the streaming media content. A channel map typically provides a list of frequencies corresponding to channel designations to map to the offered services (e.g. CNN, Discovery, HBO, etc.). When streaming media content is added to the services provided over the video delivery system, it would be advantageous to add this information to the channel map to enable the consumer device to tune to the appropriate channel in order to receive the streaming media content. Similarly, it is advantageous to update the channel maps when streaming media is sent on a DOCSIS channel, so that this information can then used by the DOCSIS cable modem for rapid acquisition. Updating the channel maps for the services provided via the DOCSIS channel may be accomplished as an extension to existing set-up and assignment mechanisms for the DOCSIS modem.

The content may be offered by the system operator 40 on one of a subscription basis or a pay-per-use basis. A portion of bandwidth of the existing delivery network 60 may be allocated to a streaming media content provider 50, 52. The content provider 50, 52 may be billed by the system operator 40 based on the amount of allocated bandwidth. In such an embodiment, digital rights management of the content, and access to the content, is controlled by the content provider 50, 52. The content may be offered by the content provider 50, 52 based on one of a subscription basis or a pay-per-use basis. Delivery of the content provided by the content provider 50, 52 may be tracked by the system operator 40, for purposes of billing verification as discussed above.

The existing video delivery system may comprise at least one of a cable video delivery system, a satellite video delivery system, and an off-air delivery system.

The out-of-band (OOB) data path 42 is used to transmit a variety of information from the system operator 40 to the consumer device 200, such as security and access control information (e.g., configuration, decryption entitlements, and authorization commands, and the like), system configuration information, electronic programming guide (EPG) information, and downloadable objects (e.g., media players, downloadable programs, and the like). The return path from the consumer device 200 to the system operator 40 is not shown; however, various return path technologies are well known. An example return path technology is the aforementioned DOCSIS scheme.

The content may be delivered to the consumer device 200 via an in-band MPEG-2 transport stream, via a cable modem utilizing Data Over Cable Service Interface Specification (DOCSIS), or any other transport method compatible with the second network 60 and the consumer device 200. Although unlikely when the bandwidth is constrained on the OOB channel, the transport stream carrying the content may be combined with the OOB transport stream 42 at, for example, an RF combiner 150, prior to being delivered to the consumer device 200.

Those skilled in the art will appreciate that the network 20 may comprise, for example, an external communication network, such as the world wide web, the Internet, a national backbone network, a privately owned wide area network, or any other network to which a consumer device may be connected on a generally world wide basis. The existing delivery network (e.g., headend network 60) may comprise a system operator controlled network, which may be, for example, a cable television network, a satellite television network, a local area network, a large area network, a national network, or other similar network where access is controlled by a system operator.

In a second exemplary embodiment, methods and systems are disclosed for providing streaming media in an existing video delivery system operated by a system operator 40. In this embodiment, the streaming media content is transcoded at transcoder 130 from a first format to a second format compatible with a consumer device 200. The transcoder 130 for transcoding the streaming media content may be located at a video delivery system headend (e.g., headend processing system 100). The transcoded streaming media content is then delivered to the consumer device 200 for decoding and display over an existing delivery network 60.

The consumer device 200 may comprise any one of a plurality of consumer devices in the video delivery system, such as a television, a set-top terminal, a personal computer, an Internet appliance associated with the video delivery system (e.g., a web pad enabled for communications with a set-top terminal), or any other display device which may be integrated into the existing video delivery system.

The transcoder 130 may convert the streaming media content into an MPEG-2 program stream. Where the streaming media content is converted into an MPEG-2 program stream, the MPEG-2 program stream may be multiplexed with additional MPEG-2 program streams at multiplexer 140 to provide a new multiplexed MPEG-2 transport stream for delivery to the consumer device 200.

Alternately, the transcoder 130 may convert the streaming media content for transport via Data Over Cable Service Interface Specification (DOCSIS). Channel maps may be updated to reflect the presence of the streaming media content on the DOCSIS channel.

A processor 110 may be provided for encapsulating the transcoded streaming media content in an MPEG-2 transport stream prior to delivery of the content to the consumer device 200 over the existing delivery network 60. Where the streaming media content is encapsulated in an MPEG-2 transport stream, the MPEG-2 transport stream may be multiplexed with additional MPEG-2 transport streams at multiplexer 140 to provide a new multiplexed MPEG-2 transport stream for delivery to the consumer device 200.

The transcoded content may be decoded and displayed by the consumer device 200 without the need for a media player 210. Alternately, a media player 210 may be downloaded to or provided in the consumer device 200 for decoding and display of the transcoded streaming media content.

A substitute player may be securely downloaded to the consumer device 200 in place of an existing player 210 in order to accommodate a different encoding scheme of the streaming media content. The existing player 210 may be a previously downloaded player or a default player installed by the manufacturer. Alternatively, an additional player may be securely downloaded to the consumer device 200 in order to accommodate a different encoding scheme of the streaming media content. In such an embodiment, the consumer device 200 would be capable of downloading and storing more than one player.

As discussed above in connection with the first embodiment, the delivery of the streaming content may be tracked by the system operator 40. A percentage of a fee for delivery of the streaming media content may be provided from a streaming media content provider 50, 52 to the system operator 40. The fee may be enabled by referral information embedded in a uniform resource locator (URL) associated with the content.

The streaming media content may be provided from within the system operator's walled garden 25. Alternately, the streaming media content may be provided from outside of the walled garden 25. The content may be provided on a conditional access basis by either the system operator 40 or a content provider 50, 52.

Digital rights management (DRM) of the content may be provided by one of the system operator 40 or a content provider 52. Digital rights management may comprise encrypting of the streaming media content for secure delivery over the existing network 60. Digital rights management may be enabled using extensible rights markup language (XrML).

In this embodiment, third party DRM schemes may be converted by processor 110 (in connection with DRM proxy device 120 as discussed above) to a system operator's native DRM scheme to enable secure delivery of streaming media content from multiple third parties over the existing delivery network. Alternately, the consumer device 200 may be enabled to accommodate multiple DRM software implementations.

The streaming media content may be provided by a third party content provider 50, 52 or the system operator 40. The player 210 (if required) may be either a third party content provider's player or a system operator's player.

Channel maps may be modified (e.g., at headend processing system 100 by processor 110) to reflect the presence of the streaming media content.

The content may be offered by the system operator 40 on one of a subscription basis or a pay-per-use basis. A portion of bandwidth of the existing delivery network 60 may be allocated to a streaming media content provider 50, 52. The content provider 50, 52 may be billed by the system operator 40 based on the amount of allocated bandwidth. In such an embodiment, digital rights management of the content, and access to the content may be controlled by the content provider 50, 52. The content may be offered by the content provider 50, 52 based on one of a subscription basis or a pay-per-use basis. The delivery of the content may be tracked by the system operator 40 for billing verification purposes.

The existing video delivery system may comprise at least one of a cable video delivery system, a satellite video delivery system, and an off-air delivery system.

It should now be appreciated that the present invention provides advantageous methods and systems for providing streaming media content to consumers using an existing video delivery system.

Although the invention has been described in connection with various illustrated embodiments, numerous modifications and adaptations may be made thereto without departing from the spirit and scope of the invention as set forth in the claims.

What is claimed is:

1. A method for providing streaming media in an existing video delivery system operated by a system operator, comprising the steps of:
securely downloading a player for streaming media content to a consumer device via an existing delivery network; and
processing said streaming media content for delivery over said existing delivery network to the consumer device for decoding and display by said player.

2. A method in accordance with claim 1, wherein said processing of said streaming media content comprises:
encapsulating said streaming media content in an MPEG-2 transport stream.

3. A method in accordance with claim 2, further comprising:
multiplexing said MPEG-2 transport stream with additional MPEG-2 transport streams to provide a multiplexed MPEG-2 transport stream for delivery to the consumer device.

4. A method in accordance with claim 1, wherein said processing of said streaming media content comprises:
providing said streaming media to said consumer device using Data Over Cable Service Interface Specification (DOCSIS).

5. A method in accordance with claim 4, further comprising:
updating channel maps to reflect the presence of the streaming media content.

6. A method in accordance with claim 1, wherein said processing of said streaming media content comprises:
transcoding said streaming media content from a first format to a second format compatible with said player.

7. A method in accordance with claim 6, wherein said second format comprises an MPEG-2 program stream.

8. A method in accordance with claim 7, further comprising:
multiplexing said MPEG-2 program stream with additional MPEG-2 program streams to provide a multiplexed MPEG-2 transport stream for delivery to the consumer device.

9. A method in accordance with claim 6, wherein said processing of said streaming media content further comprises:
encapsulating said transcoded streaming media content in an MPEG-2 transport stream.

10. A method in accordance with claim 1, further comprising:
securely downloading a substitute player to the consumer device in place of an existing player to accommodate a different encoding scheme of the streaming media content.

11. A method in accordance with claim 1, further comprising:
securely downloading an additional player to the consumer device to accommodate a different encoding scheme of the streaming media content.

12. A method in accordance with claim 1, further comprising:
tracking the delivery of said streaming media content by the system operator.

13. A method in accordance with claim 1, wherein said player is securely downloaded from within the system operator's walled garden.

14. A method in accordance with claim 13, wherein said content is provided from outside of the walled garden.

15. A method in accordance with claim 1, further comprising:
providing a percentage of a fee for delivery of said streaming media content from a streaming media content provider to said system operator.

16. A method in accordance with claim 15, wherein:
said fee is enabled by referral information embedded in a uniform resource locator associated with the content.

17. A method in accordance with claim 1, wherein said content is provided on a conditional access basis by one of the system operator or a content provider.

18. A method in accordance with claim 1, further comprising:
providing digital rights management (DRM) of the content by one of the system operator or a content provider.

19. A method in accordance with claim 18, wherein said digital rights management comprises:
encrypting of said streaming media content for secure delivery.

20. A method in accordance with claim 18, wherein said digital rights management is enabled using extensible rights markup language (XrML).

21. A method in accordance with claim 18, further comprising:
converting third party DRM schemes to a system operator's native DRM scheme to enable secure delivery of streaming media content from multiple third parties over the existing delivery network.

22. A method in accordance with claim 18, wherein said consumer device is enabled to accommodate multiple DRM software implementations.

23. A method in accordance with claim 1, wherein said streaming media content is provided by one of a third party content provider or the system operator.

24. A method in accordance with claim 1, wherein the player is one of a third party content provider's player or a system operator's player.

25. A method in accordance with claim 1, further comprising:
modifying channel maps to reflect the presence of the streaming media content.

26. A method in accordance with claim 1, wherein said content is offered by one of a content provider or the system operator on one of a subscription basis, a pay-per-use basis, or an on-demand basis.

27. A method in accordance with claim 1, further comprising:
allocating a portion of bandwidth of the existing delivery network to a streaming media content provider; and
billing said content provider based on the amount of allocated bandwidth.

28. A method in accordance with claim 27, wherein:
digital rights management of the content is controlled by the content provider; and
access to said content is controlled by the content provider.

29. A method in accordance with claim 27, wherein:
said content is offered by the content provider based on one of a subscription basis or a pay-per-use basis.

30. A method in accordance with claim 27, further comprising:
tracking the delivery of said content by the system operator.

31. A method in accordance with claim 1, wherein said existing video delivery system comprises at least one of a cable video delivery system, a satellite video delivery system, and an off-air delivery system.

32. A system for providing streaming media in an existing video delivery system operated by a system operator, comprising:
a video delivery system headend; and
a plurality of consumer devices communicating with the headend via an existing delivery network, wherein:
a player for streaming media content is downloaded from said headend to a consumer device via said network; and
a processor for processing said streaming media content for delivery over the network to the consumer device for decoding and display by said player.

33. A system in accordance with claim 32, wherein said processor encapsulates said streaming media content in an MPEG-2 transport stream.

34. A system in accordance with claim 33, further comprising:
a multiplexer for multiplexing said MPEG-2 transport stream with additional MPEG-2 transport streams to provide a multiplexed MPEG-2 transport stream for delivery to the consumer device.

35. A system in accordance with claim 32, wherein said streaming media content is delivered using Data Over Cable Service Interface Specification (DOCSIS).

36. A system in accordance with claim 35, wherein:
channel maps are updated to reflect the presence of the streaming media content.

37. A system in accordance with claim 32, further comprising:
a transcoder for transcoding streaming media content from a first format to a second format compatible with said player.

38. A system in accordance with claim 37, wherein said second format comprises an MPEG-2 program stream.

39. A system in accordance with claim 38, further comprising:
a multiplexer for multiplexing said MPEG-2 program stream with additional MPEG-2 program streams to provide a multiplexed MPEG-2 transport stream for delivery to the consumer device.

40. A system in accordance with claim 37, wherein said processor encapsulates said transcoded streaming media content in an MPEG-2 transport stream.

41. A system in accordance with claim 32, wherein:
a substitute player is securely downloaded to the consumer device in place of an existing player to accommodate a different encoding scheme of the streaming media content.

42. A system in accordance with claim 32, wherein:
an additional player is securely downloaded to the consumer device to accommodate a different encoding scheme of the streaming media content.

43. A system in accordance with claim 32, wherein:
the delivery of said streaming media content is tracked by the system operator.

44. A system in accordance with claim 32, wherein said player is securely downloaded from within the system operator's walled garden.

45. A system in accordance with claim 44, wherein said content is provided from outside of the walled garden.

46. A system in accordance with claim 32, wherein:
a percentage of a fee for delivery of said streaming media content is provided from a streaming media content provider to said system operator.

47. A system in accordance with claim 46, wherein:
said fee is enabled by referral information embedded in a uniform resource locator associated with the content.

48. A system in accordance with claim 32, wherein said content is provided on a conditional access basis by one of the system operator or a content provider.

49. A system in accordance with claim 32, wherein:
digital rights management (DRM) of the content is provided by one of the system operator or a content provider.

50. A system in accordance with claim 49, wherein said digital rights management comprises:
encrypting of said streaming media content for secure delivery.

51. A system in accordance with claim 49, wherein said digital rights management is enabled using extensible rights markup language (XrML).

52. A system in accordance with claim 49, further comprising:
a processor for converting third party DRM schemes to a system operator's native DRM scheme to enable secure delivery of streaming media content from multiple third parties over the existing delivery network.

53. A system in accordance with claim 49, wherein said consumer device is enabled to accommodate multiple DRM software implementations.

54. A system in accordance with claim 32, wherein said streaming media content is provided by one of a third party content provider or the system operator.

55. A system in accordance with claim 32, wherein the player is one of a third party content provider's player or a system operator's player.

56. A system in accordance with claim 32, wherein:
channel maps are modified to reflect the presence of the streaming media content.

57. A system in accordance with claim 32, wherein said content is offered by the system operator on one of a subscription basis or a pay-per-use basis.

58. A system in accordance with claim 32, wherein:
a portion of bandwidth of the existing delivery network is allocated to a streaming media content provider; and
said content provider is billed based on the amount of allocated bandwidth.

59. A system in accordance with claim 58, wherein:
digital rights management of the content is controlled by the content provider; and
access to said content is controlled by the content provider.

60. A system in accordance with claim 58, wherein:
said content is offered by the content provider based on one of a subscription basis or a pay-per-use basis.

61. A system in accordance with claim 58, wherein:
the delivery of said content is tracked by the system operator.

62. A system in accordance with claim 32, wherein said existing video delivery system comprises at least one of a cable video delivery system, a satellite video delivery system, and an off-air broadcast delivery system.

63. A method for providing streaming media in an existing video delivery system operated by a system operator, comprising the steps of:
transcoding said streaming media content from a first format to a second format compatible with a consumer device; and
delivering said transcoded streaming media content to said consumer device for decoding and display over an existing delivery network.

64. A method in accordance with claim 63, wherein said transcoding of said streaming media content comprises:
converting said streaming media content into an MPEG-2 program stream.

65. A method in accordance with claim 64, further comprising:
multiplexing said MPEG-2 program stream with additional MPEG-2 program streams to provide a multiplexed MPEG-2 transport stream for delivery to the consumer device.

66. A method in accordance with claim 63, wherein said transcoding of said streaming media content comprises:
converting said streaming media content for transport via Data Over Cable Service Interface Specification (DOCSIS).

67. A method in accordance with claim 66, further comprising:
updating channel maps to reflect the presence of the streaming media content.

68. A method in accordance with claim 63, further comprising:
encapsulating the transcoded streaming media content in an MPEG-2 transport stream prior to delivery to the consumer device.

69. A method in accordance with claim 68, further comprising:
multiplexing said MPEG-2 transport stream with additional MPEG-2 transport streams to provide a multiplexed MPEG-2 transport stream for delivery to the consumer device.

70. A method in accordance with claim 63, further comprising:
securely downloading a substitute player to the consumer device in place of an existing player to accommodate a different encoding scheme of the streaming media content.

71. A method in accordance with claim 63, further comprising:
securely downloading an additional player to the consumer device to accommodate a different encoding scheme of the streaming media content.

72. A method in accordance with claim 63, further comprising:
tracking the delivery of said streaming media content by the system operator.

73. A method in accordance with claim 63, wherein said streaming media content is provided from within the system operator's walled garden.

74. A method in accordance with claim 63, wherein said streaming media content is provided from outside of the walled garden.

75. A method in accordance with claim 63, further comprising:
providing a percentage of a fee for delivery of said streaming media content from a streaming media content provider to said system operator.

76. A method in accordance with claim 75, wherein:
said fee is enabled by referral information embedded in a uniform resource locator associated with the content.

77. A method in accordance with claim 63, wherein said content is provided on a conditional access basis by one of the system operator or a content provider.

78. A method in accordance with claim 63, further comprising:
providing digital rights management (DRM) of the content by one of the system operator or a content provider.

79. A method in accordance with claim 78, wherein said digital rights management comprises:
encrypting of said streaming media content for secure delivery.

80. A method in accordance with claim 78, wherein said digital rights management is enabled using extensible rights markup language (XrML).

81. A method in accordance with claim 78, further comprising:
converting third party DRM schemes to a system operator's native DRM scheme to enable secure delivery of streaming media content from multiple third parties over the existing delivery network.

82. A method in accordance with claim 78, wherein said consumer device is enabled to accommodate multiple DRM software implementations.

83. A method in accordance with claim 63, wherein said streaming media content is provided by one of a third party content provider or the system operator.

84. A method in accordance with claim 63, further comprising:
modifying channel maps to reflect the presence of the streaming media content.

85. A method in accordance with claim 63, wherein said content is offered by the system operator on one of a subscription basis or a pay-per-use basis.

86. A method in accordance with claim 63, further comprising:
allocating a portion of bandwidth of the existing delivery network to a streaming media content provider; and
billing said content provider based on the amount of allocated bandwidth.

87. A method in accordance with claim 86, wherein:
digital rights management of the content is controlled by the content provider; and
access to said content is controlled by the content provider.

88. A method in accordance with claim 86, wherein:
said content is offered by the content provider based on one of a subscription basis or a pay-per-use basis.

89. A method in accordance with claim 86, further comprising:
tracking the delivery of said content by the system operator.

90. A method in accordance with claim 63, wherein said existing video delivery system comprises at least one of a cable video delivery system, a satellite video delivery system, and an off-air delivery system.

91. A system for providing streaming media in an existing video delivery system operated by a system operator, comprising:
a video delivery system headend;
a plurality of consumer appliances;
a transcoder located at the headend for transcoding said streaming media content from a first format to a second format compatible with a consumer device; and
an existing delivery network for delivering said transcoded streaming media content from the headend to said consumer device for decoding and display.

92. A system in accordance with claim 91, wherein said transcoder converts said streaming media content into an MPEG-2 program stream.

93. A system in accordance with claim 92, further comprising:
a multiplexer for multiplexing said MPEG-2 program stream with additional MPEG-2 program streams to provide a multiplexed MPEG-2 transport stream for delivery to the consumer device.

94. A system in accordance with claim 91, wherein said transcoder converts said streaming media content for transport via Data Over Cable Service Interface Specification (DOCSIS).

95. A system in accordance with claim 94, wherein:
channel maps are updated to reflect the presence of the streaming media content.

96. A system in accordance with claim 91, further comprising:
a processor for encapsulating said transcoded streaming media content in an MPEG-2 transport stream prior to delivery of the content to the consumer device.

97. A system in accordance with claim 96, further comprising:
a multiplexer for multiplexing said MPEG-2 transport stream with additional MPEG-2 transport streams to provide a multiplexed MPEG-2 transport stream for delivery to the consumer device.

98. A system in accordance with claim 91, wherein:
a substitute player is securely downloaded to the consumer device in place of an existing player to accommodate a different encoding scheme of the streaming media content.

99. A system in accordance with claim 91, wherein:
an additional player is securely downloaded to the consumer device to accommodate a different encoding scheme of the streaming media content.

100. A system in accordance with claim 91, wherein:
the delivery of said streaming media content is tracked by the system operator.

101. A system in accordance with claim 91, wherein said streaming media content is provided from within the system operator's walled garden.

102. A system in accordance with claim 91, wherein said streaming media content is provided from outside of the walled garden.

103. A system in accordance with claim 91, wherein:
a percentage of a fee for delivery of said streaming media content is provided from a streaming media content provider to said system operator.

104. A system in accordance with claim 103, wherein:
said fee is enabled by referral information embedded in a uniform resource locator associated with the content.

105. A system in accordance with claim 91, wherein said content is provided on a conditional access basis by one of the system operator or a content provider.

106. A system in accordance with claim 91, wherein:
digital rights management (DRM) of the content is provided by one of the system operator or a content provider.

107. A system in accordance with claim 106, wherein said digital rights management comprises:
encrypting of said streaming media content for secure delivery.

108. A system in accordance with claim 106, wherein said digital rights management is enabled using extensible rights markup language (XrML).

109. A system in accordance with claim 106, further comprising:
a processor for converting third party DRM schemes to a system operator's native DRM scheme to enable secure delivery of streaming media content from multiple third parties over the existing delivery network.

110. A system in accordance with claim 106, wherein said consumer device is enabled to accommodate multiple DRM software implementations.

111. A system in accordance with claim 91, wherein said streaming media content is provided by one of a third party content provider or the system operator.

112. A system in accordance with claim 91, further comprising:
channel maps are modified to reflect the presence of the streaming media content.

113. A system in accordance with claim 91, wherein said content is offered by the system operator on one of a subscription basis or a pay-per-use basis.

114. A system in accordance with claim 91, wherein:
a portion of bandwidth of the existing delivery network is allocated to a streaming media content provider; and
said content provider is billed based on the amount of allocated bandwidth.

115. A system in accordance with claim 114, wherein:
digital rights management of the content is controlled by the content provider; and access to said content is controlled by the content provider.

116. A system in accordance with claim 114, wherein:
said content is offered by the content provider based on one of a subscription basis or a pay-per-use basis.

117. A system in accordance with claim 114, wherein:
the delivery of said content is tracked by the system operator.

118. A system in accordance with claim 91, wherein said existing video delivery system comprises at least one of a cable video delivery system, a satellite video delivery system, and an off-air delivery system.
